(19) United States
(12) Patent Application Publication
(10) Pub. No.: US 2008/0065266 A1
(43) Pub. Date: Mar. 13, 2008

(54) MOBILE ROBOT AND OPERATING METHOD THEREOF

(75) Inventor: Sang Yun Kim, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/852,543

(22) Filed: Sep. 10, 2007

(30) Foreign Application Priority Data
Sep. 11, 2006 (KR) 10-2006-0087531

(51) Int. Cl. G06F 19/00

(52) U.S. Cl. 700/245; 901/1

(57) ABSTRACT

A mobile robot includes a first receiver that receives a header signal transmitted via a first communication method, and a second receiver that receives data signals transmitted via a second communication method different than the first communication method. The header signal indicates that the data signals will be transmitted, and each data signal corresponds to a specific area of communication coverage.

This application claims priority from Korean Patent Application No. 10-2006-0087531, filed on Sep. 11, 2006 in the Korean Intellectual Property Office, the disclosure of which is incorporated herein by reference in its entirety.

### BACKGROUND OF THE INVENTION

1. Field of the Invention

The present invention relates to a mobile robot and an operating method thereof, and more particularly, to a mobile robot and an operating method thereof in which a guide signal for notifying a mobile robot of the direction of a charging station and the distance between the mobile robot and the charging station is divided into a header signal and a number of data signals and the header signal and the data signals are transmitted using different communication methods so that the mobile robot can quickly return to the charging station.

2. Description of the Related Art

Recently, home robots for use in homes have been commercialized, and the range of application of such home robots has gradually increased.

Examples of home robots include cleaning robots. Cleaning robots are mobile robots which perform a cleaning operation by sucking up dust and dirt while traveling.

Mobile robots are equipped with rechargeable batteries. Thus, mobile robots can freely and autonomously travel from place to place using the operating power of batteries. Also, mobile robots are equipped with a plurality of sensors and can thus avoid obstacles while traveling.

Mobile robots detect the remaining power of a battery and return to a charging station if the detected remaining battery power is less than a predefined level. Mobile robots detach themselves from a charging station once being charged up and resume traveling and cleaning operations. This function is referred to as an automatic charging function.

Mobile robots receive a signal transmitted by a charging station, determine the location of the charging station, and return to the charging station using the automatic charging function whenever necessary to be charged.

However, conventional methods of returning a mobile robot to a charging station using a signal transmitted by the charging station require a charging station to periodically transmit a number of signals of a guide signal respectively representing a number of areas, thereby considerably increasing the time taken to transmit a guide signal. Thus, it takes a long time for a mobile robot to receive a guide signal, determine the distance between the mobile robot and the charging station and set the heading direction of the mobile robot.

In other words, the transmission of a guide signal by a charging station is performed by transmitting a header signal, transmitting one of a plurality of data signals a predefined amount of time after the transmission of the header signal, and transmitting another of the data signals a predefined amount of time after the transmission of the first data signal. Thus, it takes too much time for a charging station to transmit a guide signal, and it takes as much time for a mobile robot to receive a guide signal. Therefore, it takes too much time for a mobile robot to return to a charging station. In addition, since it takes a long time for a charging station to transmit a guide signal and it also takes a long time for a mobile robot to receive a guide signal, data loss is highly likely to occur during the transmission of a guide signal between a charging station and a mobile robot.

### SUMMARY OF THE INVENTION

The present invention provides a mobile robot and an operating method thereof which can facilitate the transmission/reception and the analysis of a guide signal, can enable a mobile robot to easily determine the heading direction of the mobile robot, and can reduce the time taken for the mobile robot to return to a charging station by dividing the guide signal for indicating the direction of a charging station and the heading direction of the mobile robot into a header signal and a number of data signals and transmitting the header signal and the data signals using different communication methods.

According to an aspect of the present invention, there is provided a mobile robot which includes a first receiver that receives a header signal transmitted via a first communication method, and a second receiver that receives data signals transmitted via a second communication method different than the first communication method. The header signal indicates that the data signals will be transmitted, and each data signal corresponds to a specific area of communication coverage.

The first receiver may be a radio frequency receiver, and the second receiver may be an infrared receiver. The mobile robot may include a control unit that analyzes the header signal and the data signals, determines a location of the mobile robot based on the analysis, and sets a heading direction of the mobile robot to allow the mobile robot to travel to a charging station.

The control unit may determine the location of the mobile robot by calculating a time interval between reception of the header signal and reception of the data signals, and calculating a time taken to receive the data signals. The control unit may determine a distance between the mobile robot and the charging station according to an intensity of the data signals. The control unit may set the heading direction of the mobile robot by determining a distance between the mobile robot and the charging station, and determining the areas of coverage corresponding to the data signals. The control unit may determine that the mobile robot is located in an area in which the specific coverage areas corresponding to the data signals overlap.

There is also provided a method for controlling a mobile robot which includes receiving a header signal transmitted via a first communication method, receiving data signals transmitted via a second communication method different than the first communication method, analyzing the header signal and the data signals, determining a location of the mobile robot based on the analysis, and setting a heading direction of the mobile robot to allow the mobile robot to travel to a charging station. The header signal indicates that the data signals will be transmitted, and each data signal corresponds to a specific area of communication coverage.

The first communication method may be a radio frequency communication method, and the second communication method may be an infrared communication method. The location of the mobile robot may be determined by calculating a time interval between reception of the header signal and reception of the data signals, and calculating a time taken to receive the data signals.

The method may also include determining a distance between the mobile robot and the charging station according to an intensity of the data signals. The heading direction of the mobile robot may be set by determining a distance between the mobile robot and the charging station, and determining the areas of coverage corresponding to the data signals. The method may also include determining that the mobile robot is located in an area in which the specific coverage areas corresponding to the data signals overlap.

There is also provided a charging station for a mobile robot which includes a first transmitter that transmits a header signal via a first communication method, and a second transmitter that transmits data signals via a second communication method different than the first communication method. The header signal indicates that the data signals will be transmitted, and each data signal corresponds to a specific area of communication coverage.

The first transmitter may be a radio frequency transmitter and the second transmitter may be an infrared (IR) transmitter. The IR transmitter may include a plurality of IR transmission modules having different areas of communication coverage. The charging station may include a control unit that controls the IR transmission modules to sequentially transmit the data signals after the first transmitter transmits the header signal. The charging station may also include a control unit that varies intensities of the data signals to vary ranges of the areas of communication coverage.

### BRIEF DESCRIPTION OF THE DRAWINGS

The above and other features and advantages of the present invention will become more apparent by describing in detail preferred embodiments thereof with reference to the attached drawings in which:

FIG. 1 illustrates a mobile robot and a charging station according to an embodiment of the present invention;

FIG. 2 illustrates a block diagram of the charging station;

FIG. 3 illustrates a block diagram of the mobile robot;

FIG. 4 illustrates the range of communication of the charging station, according to an embodiment of the present invention;

FIG. 5 illustrates the waveforms of a plurality of guide signals transmitted by the charging station, according to an embodiment of the present invention;

FIG. 6 illustrates the waveforms of a plurality of guide signals received by the mobile robot, according to an embodiment of the present invention;

FIG. 7 illustrates the traveling path of the mobile robot in response to the guide signals illustrated in FIG. 6;

FIG. 8 illustrates the waveforms of a plurality of guide signals received by the mobile robot, according to another embodiment of the present invention;

FIG. 9 illustrates the communication range of the charging station, according to another embodiment of the present invention;

FIG. 10 illustrates the waveforms of a plurality of guide signals transmitted by the charging station, according to another embodiment of the present invention;

FIG. 11 illustrates the waveforms of a plurality of guide signals received by the mobile robot, according to another embodiment of the present invention;

FIG. 12 illustrates the traveling path of the mobile robot in response to the guide signals illustrated in FIG. 11;

FIG. 13 illustrates a flowchart of a method of returning a mobile robot to a charging station according to an embodiment of the present invention.

### DETAILED DESCRIPTION OF THE INVENTION

The present invention will hereinafter be described in detail with reference to the accompanying drawings in which exemplary embodiments of the invention are shown.

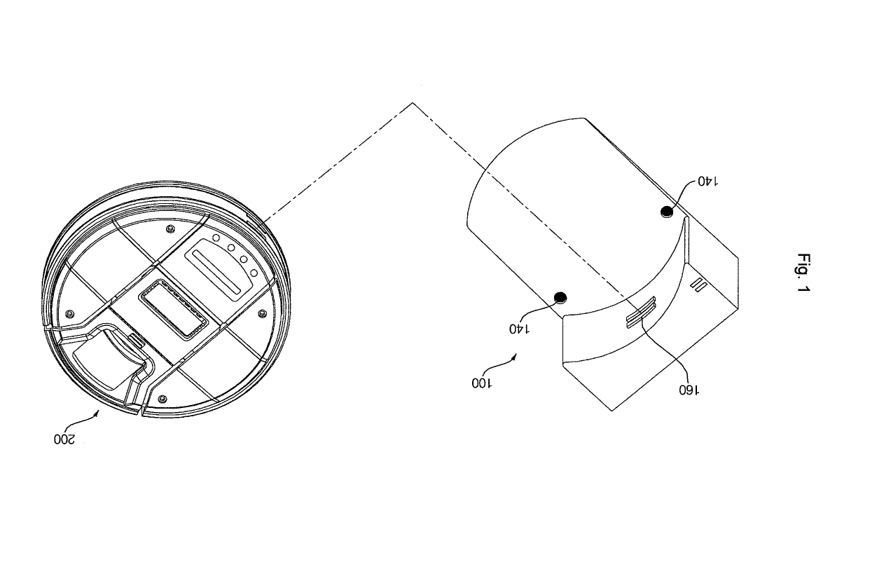

FIG. 1 illustrates a mobile robot 200 and a charging station 100 according to an embodiment of the present invention. Referring to FIG. 1, the charging station 100 transmits a guide signal for indicating the direction of the charging station 100 and the distance between the charging station 100 and the mobile robot 200, thereby helping the mobile robot 100 to return to the charging station 100. The charging station 100 supplies a charging current to the mobile robot 100 when the mobile robot 100 docks. The mobile robot 200 includes means of travel and can thus travel with the aid of the means of travel.

In this embodiment, the mobile robot 200 is a cleaning robot. However, the present invention is not restricted to this. In other words, the present invention can be applied to various mobile robots, other than a cleaning robot, as long as they can travel with the aid of a travel unit and can return to a charging station whenever necessary to be charged.

The charging station 100 transmits a guide signal for guiding the mobile robot 200 and enables the mobile robot 200 to return to the charging station 100 upon receiving the guide signal. More specifically, the charging station 100 may divide a guide signal into a header signal and a number of data signals and transmit the header signal and the data signals using different communication methods. In this manner, the charging station 100 can transmit a guide signal within a relatively short time. A header signal is a reference signal indicating that a number of data signals are to be transmitted, and a plurality of data signals may be transmitted throughout different areas.

When the mobile robot 200 detects a battery shortage while traveling or sucking up dust and dirt, the mobile robot 200 may return to the charging station 100 by receiving a header signal and a number of data signals from the charging station 100, determining the distance between the mobile robot 200 and the charging station 100 and the direction of the charging station 100 based on the header signal and the data signals, determining the heading direction of the mobile robot 200 and correcting the location of the mobile robot 200.

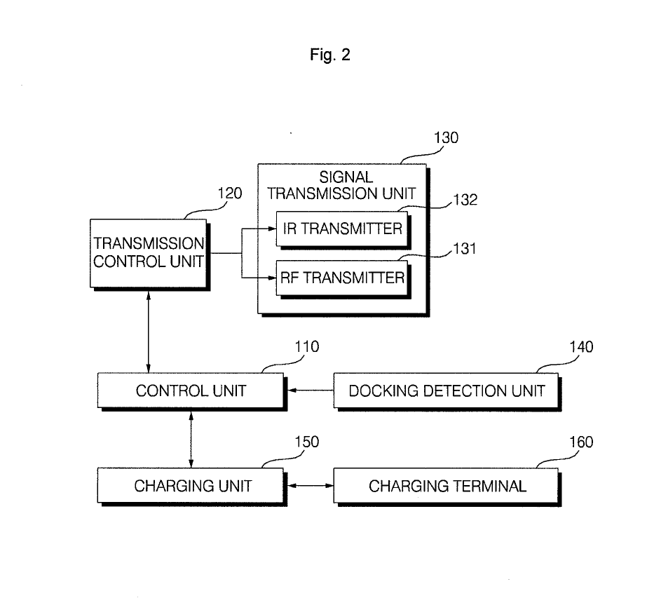

FIG. 2 illustrates a block diagram of the charging station 100. Referring to FIG. 2, the charging station 100 includes a signal transmission unit 130, a transmission control unit 120, and a control unit 110. The signal transmission unit 130 notifies the mobile robot 100 of the location of the charging station 100 by transmitting a guide signal, and can thus enable the mobile robot 100 to return to and dock at the charging station 100. The transmission control unit 120 controls the transmission of the guide signal and supplies operating power. The control unit 110 applies a control signal for controlling the guide signal to the transmission control unit 120.

The charging station 100 also includes a docking detection unit 140 which determines whether the mobile robot 200 docks at the charging station 100 and a charging unit 150 which supplies a charging current to the mobile robot 200 through a charging terminal 160.

The signal transmission unit 130 may include an IR transmitter 132 which transmits one or more data signals and a radio frequency (RF) transmitter 131 which transmits a header signal before the transmission of the data signals by the IR transmitter 132.

The RF transmitter 131 transmits a header signal which is the beginning of a guide signal, indicates that a number of data signals are to be transmitted, and includes information regarding the data signals using an RF communication method. The RF transmitter 131 generates a signal belonging to a predetermined frequency band based on a control signal transmitted by the control unit 110 and operating power provided by the transmission control unit 120, and transmits a header signal at regular time intervals.

The IR transmitter 132 includes one or more IR transmission modules (not shown). The IR transmission modules transmit data signals throughout different areas. The IR transmission modules are driven by the transmission control unit 120 which operates in response to the control signal transmitted by the control unit 110. In this manner, the IR transmitter 132 transmits an IR signal.

The transmission control unit 120 controls the supply of power to the IR transmitter 132 and the RF transmitter 131 in response to the control signal transmitted by the control unit 110, thereby controlling the transmission of signals by the IR transmitter 132 and the RF transmitter 131 (particularly, the intensity of signals and when to transmit signals). More specifically, the transmission control unit 120 controls the operations of the RF transmitter 131 and the IR transmitter 132 so that the IR transmitter 132 can transmit a number of data signals after the transmission of a header signal by the RF transmitter 131.

The docking detection unit 140 determines whether the mobile robot 200 docks at the charging station 100 based on whether the mobile robot is placed in contact with the charging terminal 160, and transmits a detection signal corresponding to the result of the determination to the control unit 110. When a command to initiate a charging operation is received from the control unit 110, the charging unit 150 supplies a charging current to the charging terminal 160.

The control unit 110 controls the transmission of a guide signal by the transmission control unit 120. The control unit controls the supply of a charging current by the charging unit 150 according to the detection signal transmitted by the docking detection unit 140. The control unit 110 controls a guide signal to be divided into a header signal and a number of data signals. Then, the control unit 110 controls the RF transmitter 131 to transmit the header signal and controls the IR transmitter 132 to transmit the data signals. The control unit 110 drives the IR transmitter 132 and the RF transmitter 131 at regular time intervals so that a guide signal can be transmitted periodically.

The control unit 110 controls the IR transmitter 132 to be driven after the transmission of a header signal by the RF transmitter 131. Also, the control unit 110 controls the IR transmission modules of the IR transmitter 132 so that a plurality of data signals respectively transmitted by the IR transmission modules of the IR transmitter 132 can be transmitted in a row.

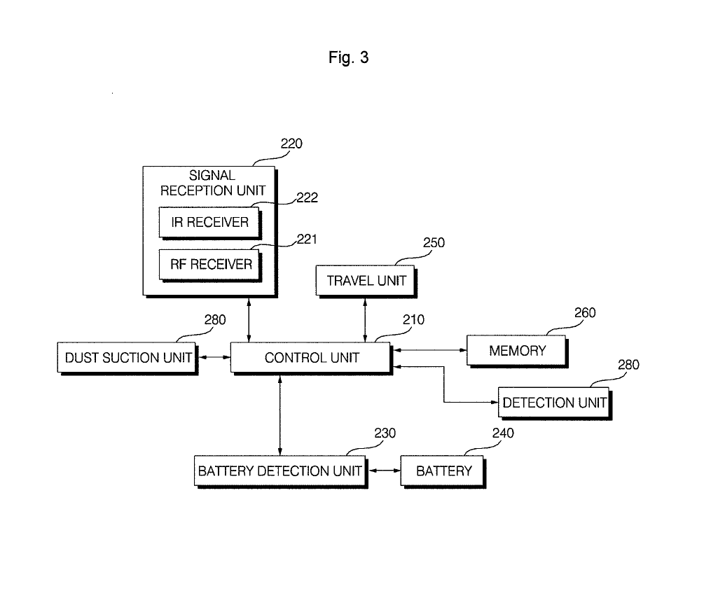

FIG. 3 illustrates a block diagram of the mobile robot 200. Referring to FIG. 3, the mobile robot 200 includes a signal reception unit 220 which receives a guide signal transmitted by the charging station 100 and a robot control unit 210 which calculates the direction between the mobile robot 200 and the charging station 100 and the direction of the charging station 100 based on the guide signal received by the signal reception unit 220 and controls the heading direction of the mobile robot 200 according to the results of the calculation. The mobile robot 200 also includes a travel unit 250 which enables the mobile robot 200 to travel in response to a control command; a dust suction unit 270 which sucks up dust and dirt while the mobile robot 200 travels; a detection unit 280 which includes at least one sensor for detecting an obstacle; a memory 260 which stores the result of analysis of a guide signal by the robot control unit 210 and control data regarding the travel of the mobile robot 200; a battery 240 which provides operating power to the mobile robot 200; and a battery detection unit 230 which detects the degree to which the battery 240 is charged and the remaining power of the battery 240.

The signal reception unit 220 includes an IR receiver 222 and an RF receiver 221 which receive a guide signal transmitted by the charging station 100. The RF receiver 221 receives a wireless RF signal belonging to a predetermined frequency band. More specifically, the RF receiver 221 receives a header signal transmitted by the RF transmitter 131 of the charging station 100 and applies the received header signal to the robot control unit 210. The IR receiver 222 may include one or more IR reception modules which receive IR signals belonging to a predetermined frequency band. The IR receiver 222 receives a number of data signals transmitted by the IR transmitter 132 of the charging station 100 and applies the received data signals to the robot control unit 210.

The battery detection unit 230 often measures the degree to which the battery 240 is charged and the remaining power of the battery 240. If the remaining power of the battery 240 is less than a predefined value, the battery detection unit 230 applies to the robot control unit 210 an alarm signal indicating a shortage of battery power and a request signal requesting the mobile robot 200 to return to the charging station 100.

The travel unit 250 includes means of travel and drives the means of travel according to a heading direction set by the robot control unit 210 and a location correction command so that the mobile robot 200 can move to a designated location. The detection unit 280 detects an obstacle using the sensors thereof, and applies the result of the detection to the robot control unit 210 so that the heading direction of the mobile robot 200 can be modified. The dust suction unit 270 includes means for sucking up air and sucks up dust and dirt while the mobile robot 200 travels with the aid of the travel unit 250. More specifically, the dust suction unit 270 includes means for sucking up air and means for condensing dust and performs a cleaning operation by sucking up dust and dirt.

The robot control unit 210 determines whether the mobile robot 200 needs to return to the charging station based on the alarm signal and the request signal transmitted by the battery detection unit 230 and determines the heading direction of the mobile robot 200 based on data transmitted by the signal reception unit 220.

The robot control unit 210 analyzes a header signal received by the RF receiver 221 and a number of data signals received by the IR receiver 222, determines the heading direction and the traveling path of the mobile robot 200 based on the data present in the memory 260, and applies a control command to the travel unit 250.

More specifically, when a header signal is received from the RF receiver 221, the robot control unit 210 starts to count time and determines whether a signal is received from the IR receiver 222 within a predetermined amount of time after the reception of the header signal. If a signal is received from the IR receiver 222 within the predetermined amount of time after the reception of the header signal, the robot control unit 210 determines the number of data signals received after the reception of the header signal, and determines the distance between the mobile robot 200 and the charging station 100 and the direction of the charging station 100 by analyzing the header signal and then analyzing the signal with reference to data included in the header signal.

The robot control unit 210 may determine the type of the signal and an area represented by the signal based on whether the corresponding signal has been received immediately or an amount of time after the reception of the header signal, and calculates the location of the mobile robot 200 and the distance between the mobile robot 200 and the charging station 100 based on the results of the determination. The robot control unit 210 may determine the distance between the mobile robot 200 and the charging station 100 based on the intensity of the signal.

The determination of the distance between the mobile robot 200 and the charging station 100 and the direction of the charging station 100 based on a guide signal will hereinafter be described in further detail.

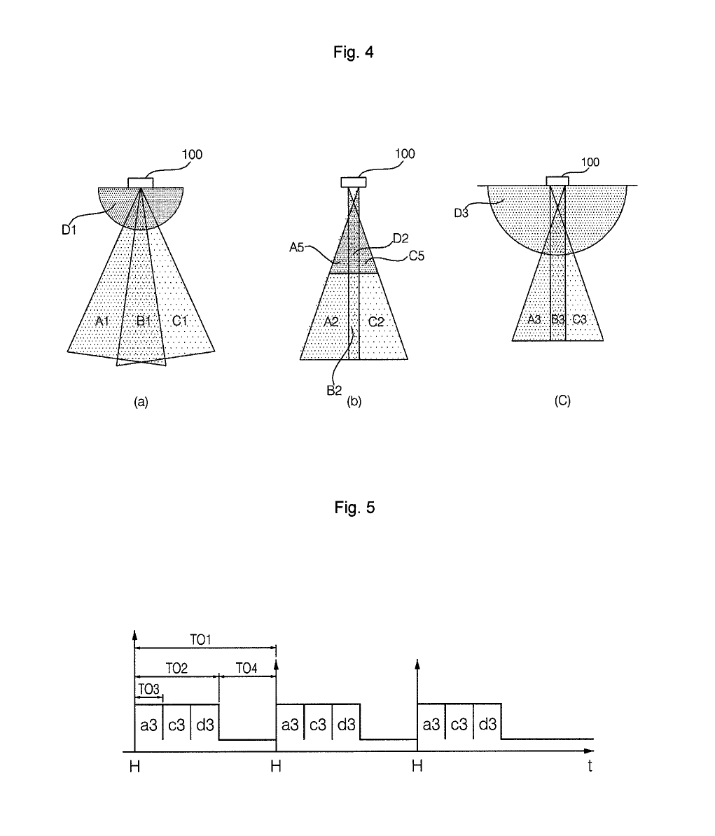

FIG. 4 illustrates the range of communication of the charging station 100. As described above, the charging station 100 transmits a guide signal, and the communication range of the charging station 100 is divided as illustrated in FIG. 4.

More specifically, referring to FIG. 4(a), the IR transmitter 132 of the signal transmission unit 130 of the charging station 100 may include first, second and third IR transmission modules. A first area A1 is the communication range of the first IR transmission module, and thus, a data signal transmitted by the first IR transmission module can be received in the first area A1. A second area C1 is the communication range of the second IR transmission module, and thus, a data signal transmitted by the second IR transmission module can be received in the second area C1. A third area D1 is the communication range of the third IR transmission module, and thus, a data signal transmitted by the third IR transmission module can be received in the third area D1. A fourth area B1 is the overlapping area of the first and second areas A1 and C1, and thus, the data signals transmitted by the first and second IR transmission modules can both be received in the fourth area B1. Since the third area D1 is closer than the first and second areas A1 and C1 to the charging station 100, the data signal transmitted by the third IR transmission module has a lower intensity than the data signals transmitted by the first and second IR transmission modules.

Referring to FIG. 4(b), the IR transmitter 132 may include fourth and fifth IR transmission modules. A fifth area A2 is the communication range of the fourth IR transmission module, and thus, a data signal transmitted by the fourth IR transmission module can be received in the fifth area A2. A sixth area C2 is the communication range of the fifth IR transmission module, and thus, a data signal transmitted by the fifth IR transmission module can be received in the sixth area C2. A seventh area B2 is the overlapping area of the fifth and sixth areas A2 and C2, and thus, the data signals transmitted by the fourth and fifth IR transmission modules can both be received in the seventh area B2. A fifteenth area A5 is closer than the seventh area A2 to the charging station 100, data signals with a lower intensity than that of the data signals transmitted by the fourth IR transmission modules can be received in the fifteenth area A5. A sixteenth area C5 is closer than the sixth area C2 to the charging station 100, data signals with a lower intensity than that of the data signals transmitted by the fifth IR transmission modules can be received in the sixteenth area C5. An eighth area D2 is part of the seventh area B2, and particularly, the overlapping area of the fifteenth area A5 and the sixteenth area C5. However, since the eighth area D2 is closer than the seventh area B2 to the charging station 100, data signals with a lower intensity than that of the data signals transmitted by the fourth and fifth IR transmission modules can be received in the eighth area D2. Thus, the eighth area D2 can be differentiated from the seventh area B2 according to the intensity of data signals that can be received therein.

The IR transmitter 132 may also include a guide element for limiting the range of communication of the IR transmitter 132. In other words, referring to FIG. 4(b) a guide element may be disposed on one side of the IR transmitter so that the area D2 can become rectangular.

Referring to FIG. 4(c), the IR transmitter 132 may include sixth through eighth IR transmission modules. A ninth area A3 is the communication range of the sixth IR transmission module, and thus, a data signal transmitted by the sixth IR transmission module can be received in the ninth area A3. A tenth area C3 is the communication range of the seventh IR transmission module, and thus, a data signal transmitted by the seventh IR transmission module can be received in the tenth area C3. An eleventh area D3 is the communication range of the eighth IR transmission module, and thus, a data signal transmitted by the eighth IR transmission module can be received in the eleventh area D3. A twelfth area B3 is the overlapping area of the ninth area A3 and the tenth area C3, and thus, the data signals transmitted by the sixth and seventh IR transmission modules can both be received in the twelfth area B3. Since the eleventh area D3 is closer than the ninth and tenth areas A3 and C3 to the charging station 100, the data signal transmitted by the eighth IR transmission module has a lower intensity than the data signals transmitted by the sixth and seventh IR transmission modules.

A guide signal transmitted by the charging station 100 will hereinafter be described in further detail.

FIG. 5 illustrates the waveforms of a plurality of guide signals transmitted by the charging station 100 according to an embodiment of the present invention. Referring to FIG. 5, the signal transmission unit 130 transmits a header signal H with the aid of the RF transmitter 131 in order to indicate that a number of data signals, i.e., data signals a3, c3, and d3, will be transmitted in a row immediately after the transmission of the header signal H. In this embodiment, the communication range of the charging station 100 is divided as illustrated in FIG. 4(c), and the data signals a3, c3, and d3 are transmitted throughout the ninth area A3, the tenth area C3, and the eleventh area D3, respectively.

More specifically, the transmission control unit 120 controls the IR transmitter 132 to transmit the data signals a3, c3, and d3 in a row immediately after the transmission of the header signal H by the RF transmitter 131.

The IR transmitter 132 transmits each of the data signals a3, c3, and d3 for a predetermined amount of time T03 throughout the ninth, tenth and eleventh areas A3, C3, and D3, respectively. The time taken to transmit each of the data signals a3, c3, and d3 will hereinafter be referred to as a unit time period. The time taken to transmit all the data signals a3, c3, and d3, i.e., T02, is the same as the result of multiplying the time taken to transmit each of the data signals a3, c3, and d3 by 3, i.e., the length of three unit time periods combined. The transmission of the header signal H and the data signals a3, c3, and d3 may be performed at intervals of a predefined time T01. An interval T04 between the transmission of the data signal d3 and the transmission of the next header signal H is the same as the result of subtracting T02 from T01. Time information regarding T01, T02, T03, and T04 may be included in a header signal, and then transmitted to the mobile robot 200. T02 and T01 may vary according to the number of data signals of a guide signal.

For example, referring to FIG. 5, a guide signal includes a header signal and three data signals, i.e., first, second and third data signals, and there is an interval T04 between the transmission of the third data signal and the transmission of a header signal of a next guide signal. In this case, the time taken to transmit the guide signal includes three unit time periods (3×T03) and the interval T04. Thus, if a unit time period T03 is 1 ms and the interval T04 is 0.5 ms, the time taken to transmit the guide signal is 3.5 ms (=3 ms+0.5 ms).

Once the charging station 100 outputs a guide signal including a header signal H and data signals a3, c3, and d3, the mobile robot 200 determines the direction between the mobile robot 200 and the charging station 100 and the direction of the charging station based on the header signal and the data signals a3, c3, and d3.

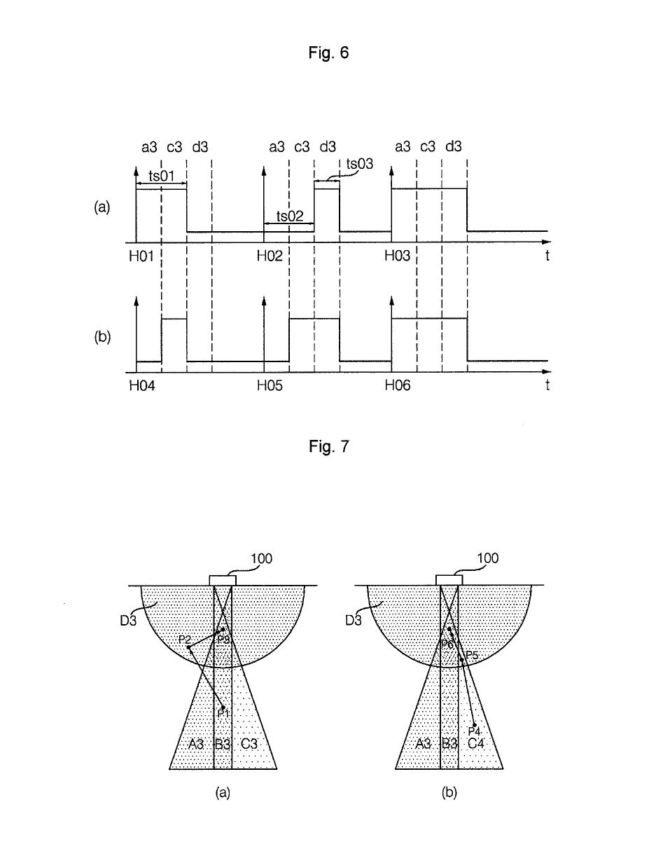

FIG. 6 illustrates the waveforms of a plurality of guide signals received by the mobile robot 200, according to an embodiment of the present invention. Referring to FIG. 6, the signal reception unit 220 of the mobile robot 200 receives a guide signal transmitted by the charging station 100. The signal reception unit 220 applies the guide signal to the robot control unit 210. Then, the robot control unit 210 calculates the distance between the mobile robot 200 and the charging station 100 and the direction of the charging station 100 based on the guide signal.

In this embodiment, the IR transmitter 132 includes sixth through eighth IR transmission modules which respectively transmit data signals a3, c3 and d3, and the communication range of the charging station 100 is divided as illustrated in FIG. 4(c).

FIG. 6(a) illustrates first through third guide signals received by the signal reception unit 220 of the mobile robot 200. Referring to FIG. 6(a), the RF receiver 221 of the signal reception unit 220 receives first through third header signals H01 through H03 of the first through third guide signals. Then, the robot control unit 210 calculates the number of data signals received after the reception of each of the first through third header signals H01 through H03 by comparing the amount of time for which a signal is received after the reception of each of the first through third header signals H01 through H03 with the length of a unit time period, and determines the location of the mobile robot 200 based on the results of the calculation.

Referring to the first guide signal of FIG. 6(a), a signal is received for two unit time periods (ts01) immediately after the reception of the first header signal H01. Thus, the robot control unit 210 determines that two data signals a3 and c3 respectively transmitted by the sixth and seventh IR transmission modules of the IR transmitter 132 have been received in a row. Accordingly, the robot control unit 210 determines that the mobile robot 200 is located in the twelfth area B3 in which the data signals a3 and c3 can both be received. Since a data signal d3 transmitted by the eighth IR transmission module of the IR transmitter 132 has not been received, the robot control unit 210 determines that the mobile robot 200 is located in the twelfth area B3, but not in a close range of the charging station 100.

Referring to the second guide signal of FIG. 6(a), a signal is received for one unit time period (ts03) two unit time periods after the reception of the second header signal H02. Thus, the robot control unit 210 determines that a data signal d3 transmitted by the eighth IR transmission module of the IR transmitter 132 has been received. Accordingly, the robot control unit 210 determines that the mobile robot 200 is located in the eleventh area D3.

Referring to the third guide signal of FIG. 6(a), a signal is received for three unit time periods immediately after the reception of the third header signal H03. Thus, the robot control unit 210 determines that three data signals a3, c3, and d3 respectively transmitted by the sixth, seventh, and eighth IR transmission modules of the IR transmitter 132 have been received in a row. Accordingly, the robot control unit 210 determines that the mobile robot 200 is located within a close range of the charging station 100, and particularly, in the overlapping area of the twelfth area B3 and the eleventh area D3.

In this manner, the robot control unit 210 determines the location of the mobile robot 200 upon receiving a guide signal and enables the mobile robot 200 to move toward the charging station 100.

FIG. 6(b) illustrates fourth through sixth guide signals received by the signal reception unit 220 of the mobile robot 200. Referring to the fourth guide signal of FIG. 6(b), a data signal c3 is received one unit time period after the reception of a fourth header signal H04. Thus, the robot control unit 210 determines that the mobile robot 200 is located in the tenth area C3.

Referring to the fifth guide signal of FIG. 6(b), two data signals c3 and d3 respectively transmitted by the seventh and eighth IR transmission modules of the IR transmitter 132 are received in a row one unit time period after the reception of a fifth header signal H05. Thus, the robot control unit 210 determines that the mobile robot 200 is located in the overlapping area of the tenth area C3 and the eleventh area D3. Accordingly, the robot control unit 210 concludes that the mobile robot 200 is within a predetermined range of the charging station 100 and can enter the twelfth area B3 by moving to the left.

Referring to the sixth guide signal of FIG. 6(b), three data signals a3, c3, and d3 are received in a row immediately after the reception of a sixth header signal H06. Thus, the robot control unit 210 determines that the mobile robot 200 is located in the overlapping area of the twelfth area B3 and the eleventh area D3.

FIG. 7 illustrates the traveling path of the mobile robot 200 in response to the first through sixth guide signals illustrated in FIG. 6. More specifically, FIG. 7(a) illustrates the traveling path of the mobile robot 200 in response to the first through third guide signals illustrated in FIG. 6(a).

Referring to FIG. 7(a) the mobile robot 200 moves from a first point P1 in the twelfth area B3 to a second point P2 in the eleventh area D3 and then from the point P2 to a point P3 in the twelfth area B3 in response to the first through third guide signals.

FIG. 7(b) illustrates the traveling path of the mobile robot 200 in response to the fourth through sixth guide signals illustrated in FIG. 6(b). Referring to FIG. 7(b), the mobile robot 200 moves from a fourth point P4 in the tenth area C3 to a fifth point P5 in the overlapping area of the tenth area C3 and the eleventh area D3 and then from the fifth point P5 to a sixth point P6 in the overlapping area of the eleventh area D3 and the twelfth area B3 in response to the fourth through sixth guide signals.

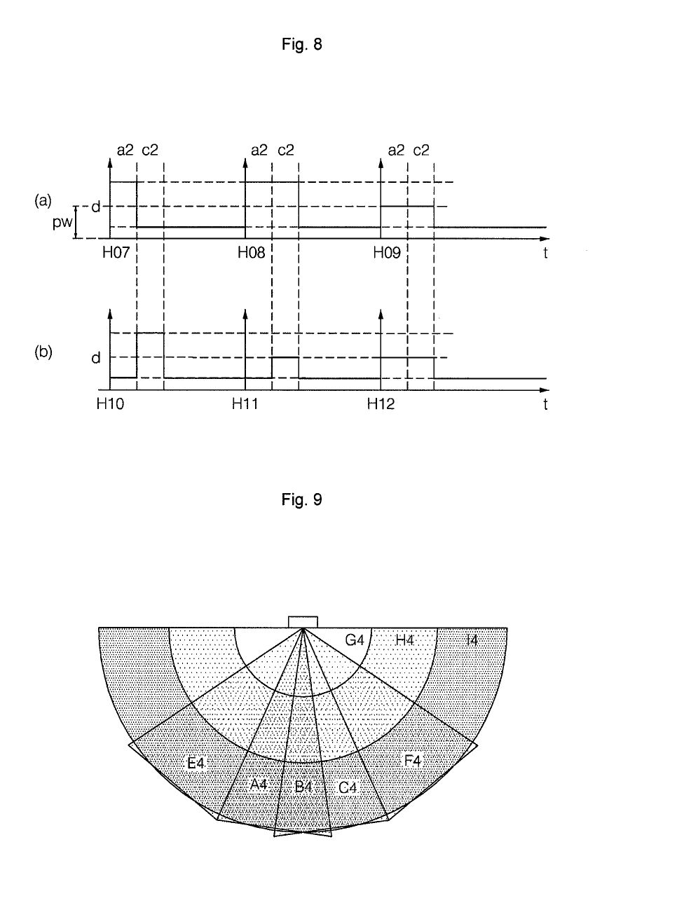

FIG. 8 illustrates the waveforms of a plurality of guide signals received by the mobile robot 200, according to another embodiment of the present invention. In this embodiment, the IR transmitter 132 of the charging station 100 includes fourth and fifth IR transmission modules which respectively transmit data signals a2 and c2, the communication range of the charging station 100 is divided as illustrated in FIG. 4(b), and the IR transmitter 132 transmits data signals a2 and c2 throughout a close range of the charging station 100 with a different intensity from that of data signals a2 and c2 transmitted throughout the areas A5 and C5.

Referring to FIG. 8, a guide signal includes a header signal and two data signals, and thus, the interval of the transmission of a header signal is 2.5 ms.

More specifically, FIG. 8(a) illustrates seventh through ninth guide signals received by the signal reception unit 220 of the mobile robot 200. Referring to the seventh guide signal of FIG. 8(a), a signal with a higher intensity than a reference intensity PW is received for one unit time period immediately after the reception of a seventh header signal H07. Thus, the robot control unit 210 determines that a data signal a2 transmitted by the fourth IR transmission module of the IR transmitter 132 has been received. Accordingly, the robot control unit 210 determines that the mobile robot is located in the fifth area A2.

Referring to the eighth guide signal of FIG. 8(a), a signal with a higher intensity than the reference intensity PW is received for two unit time periods immediately after the reception of an eighth header signal H08. Thus, the robot control unit 210 determines that two data signals a2 and c2 respectively transmitted by the fourth and fifth IR transmission modules of the IR transmitter 132 have been received in a row. Accordingly, the robot control unit 210 determines that the mobile robot 200 has moved from the fifth area A2 to the seventh area B2, and controls the mobile robot 200 to be headed left.

Referring to the ninth guide signal of FIG. 8(a), a signal with a lower intensity than the reference intensity PW is received for two unit time periods immediately after the reception of a ninth header signal H09. Thus, the robot control unit 210 determines that two data signals a2 and c2 respectively transmitted by the fourth and fifth IR transmission modules of the IR transmitter 132 have been received in a row. Since the intensity of the two data signals a2 and c2 is lower than the reference intensity PW, the robot control unit 210 determines that the mobile robot 200 is located in the overlapping area of the seventh area B2 and a close range of the charging station 100, i.e., in the eighth area D2.

FIG. 8(b) illustrates tenth through twelfth guide signals received by the signal reception unit 220 of the mobile robot 200. Referring to the tenth guide signal of FIG. 8(b), a data signal c2 transmitted with a higher intensity than the reference intensity PW by the fifth IR transmission module of the IR transmitter 132 is received one unit time period after the reception of a tenth header signal H10. Thus, the robot control unit 210 determines that the mobile robot 200 is located in the sixth area C2.

Referring to the eleventh guide signal of FIG. 8(b), a data signal c2 transmitted with a lower intensity than the reference intensity PW by the IR transmission module of the IR transmitter 132 is received one unit time period after the reception of an eleventh header signal H011. Thus, the robot control unit 210 determines that the mobile robot 200 is located in the sixteenth area C5. In this case, since the mobile robot 200 is determined to have moved from the sixth area C2 to in the sixteenth area C5, the robot control unit 210 sets the heading direction of the mobile robot 200 so that the mobile robot 200 can be headed left forward.

Referring to the twelfth guide signal of FIG. 8(b), two data signals a2 and c2 transmitted with a lower intensity than the reference intensity PW by the fourth and fifth IR transmission modules of the IR transmitter 132 are received in a row immediately after the reception of a twelfth header signal H12. Thus, the robot control unit 210 determines that the mobile robot 200 is located in the eighth area D2.

The communication range of the charging station 100 may be further divided, and this will hereinafter be described in detail.

FIG. 9 illustrates the communication range of the charging station 100, according to another embodiment of the present invention. Referring to FIG. 9, the IR transmitter 132 of the charging station 100 may include ninth through fifteenth IR transmission modules. A twenty first area A4 is the communication range of the ninth IR transmission module, and thus, a data signal a4 transmitted by the ninth IR transmission module can be received in the twenty first area A4. A twenty third area C4 is the communication range of the tenth IR transmission module, and thus, a data signal c4 transmitted by the tenth IR transmission module can be received in the twenty third area C4. A twenty fourth area E4 is the communication range of the eleventh IR transmission module, and thus, a data signal e4 transmitted by the eleventh IR transmission module can be received in the twenty fourth area E4. A twenty fifth area F4 is the communication range of the twelfth IR transmission module, and thus, a data signal f4 transmitted by the eleventh IR transmission module can be received in the twenty fifth area f4. A twenty second area B4 is the overlapping area of the twenty first area A4 and the twenty third area c4, and thus, the data signals a4 and c4 can both be received in the twenty second area B4.

A twenty sixth area G4 is the communication range of the thirteenth IR transmission module, and thus, a data signal g4 transmitted by the thirteenth IR transmission module can be received in the twenty sixth area G4. A twenty seventh area H4 is the communication range of the fourteenth IR transmission module, and thus, a data signal h4 transmitted by the fourteenth IR transmission module can be received in the twenty seventh area H4. A twenty eighth area I4 is the communication range of the fifteenth IR transmission module, and thus, a data signal i4 transmitted by the fifteenth IR transmission module can be received in the twenty eighth area I4. The data signals g4, h4, and i4 respectively transmitted by the thirteenth through fifteenth IR transmission modules have different intensities from each other.

Alternatively, the IR transmitter 132 of the charging station 100 may only include the ninth through twelfth IR transmission modules which can transmit data signals throughout the twenty first, twenty second, twenty third, and twenty fourth twenty fifth areas A4, B4, C4, E4 and F4. The ninth through twelfth IR transmission modules may vary their communication ranges by varying the intensity of the data signals to be transmitted. In other words, data signals transmitted with a first reference intensity PW1 by the ninth through twelfth IR transmission modules may arrive in the twenty sixth area G4, data signals transmitted with a second reference intensity PW2 by the ninth through twelfth IR transmission modules may arrive in the twenty seventh area H4, and data signals transmitted with a third reference intensity PW3 by the ninth through twelfth IR transmission modules may arrive in the twenty eighth area I4.

Still alternatively, the IR transmitter 132 of the charging station may include the ninth through twelfth IR transmission modules and may also include a sixteenth IR transmission module. The ninth through twelfth IR transmission modules can transmit data signals throughout the twenty first, twenty second, twenty third, and twenty fourth twenty fifth areas A4, B4, C4, E4 and F4, and the sixteenth IR transmission module can transmit a data signal d4 throughout the twenty sixth, twenty seventh and twenty eighth areas G4, H4 and I4. In other words, a data signal d4 transmitted with the first reference intensity PW1 by the sixteenth IR transmission module may arrive in the twenty sixth area G4, a data signal d4 transmitted with the second reference intensity PW2 by the sixteenth IR transmission module may arrive in the twenty seventh area H4, and a data signal d4 transmitted with the third reference intensity PW3 by the sixteenth IR transmission module may arrive in the twenty sixth area I4.

The charging station 100 transmits a guide signal in the above-mentioned manner and thus enables the mobile robot 200 to return to the charging station 100.

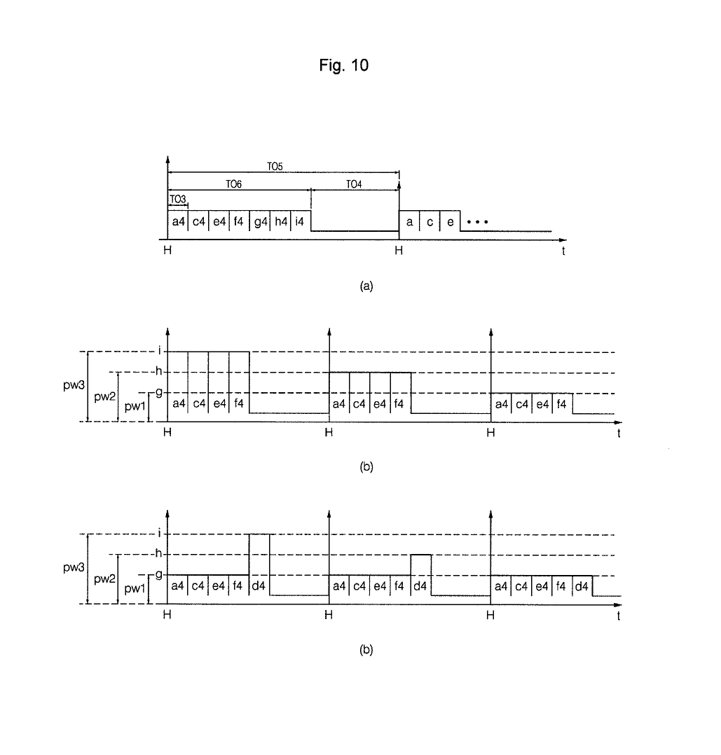

FIG. 10 illustrates the waveforms of a plurality of guide signals transmitted by the charging station 100, according to another embodiment of the present invention. In this embodiment, the communication range of the charging station 100 is divided as illustrated in FIG. 10. Referring to FIG. 10(a), the IR transmitter 132 of the charging station 100 may include ninth through fifteenth IR transmission modules. The IR transmitter 132 transmits a header signal H with the aid of the RF transmitter 131 and transmits seven data signals a4, c4, e4, f4, g4, h4, and i4 with the aid of the ninth through fifteenth IR transmission modules. Since the time taken to transmit each of seven data signals a4, c4, e4, f4, g4, h4, and i4 of a first guide signal is the same as one unit time period T03 and there is an interval T04 between the transmission of the data signal i4 of the first guide signal and the transmission of a header signal of a second guide signal, the interval of the transmission of a guide signal, i.e., T05, may be 7.5 ms (=7×T03+T04).

Referring to FIG. 10(b), the IR transmitter 132 of the charging station 100 may include ninth through twelfth IR transmission modules which respectively transmit data signals a4, c4, e4 and f4. More specifically, the IR transmitter 132 may transmit data signals a4, c4, e4 and f4 of a first guide signal in a row with the third reference intensity PW3, transmit data signals a4, c4, e4 and f4 of a second guide signal in a row with the second reference intensity PW2 and transmit data signals a4, c4, e4 and f4 of a third guide signal in a row with the first reference intensity PW1. Alternatively, the IR transmitter 132 may transmit the data signals a4, c4, e4 and f4 of the first guide signal in a row with the first reference intensity PW1, transmit the data signals a4, c4, e4 and f4 of the second guide signal in a row with the second reference intensity PW2 and transmit the data signals a4, c4, e4 and f4 of the third guide signal in a row with the third reference intensity PW3.

Referring to FIG. 10(c), the IR transmitter 132 of the charging station 100 may include ninth through twelfth IR transmission modules and a sixteenth IR transmission module. The ninth through twelfth IR transmission modules transmit data signals a4, c4, e4, and f4, respectively, of each guide signal with the first reference intensity PW1. The sixteenth IR transmission module transmits a data signal d4 of a first guide signal with the third reference intensity PW3, transmits a data signal d4 of a second guide signal with the second reference intensity PW2, and transmits a data signal d4 of a third guide signal with the first reference intensity PW1. Alternatively, the sixteenth IR transmission module may transmit the data signal d4 of the first guide signal with the first reference intensity PW1, transmit the data signal d4 of the second guide signal with the second reference intensity PW2, and transmit the data signal d4 of the third guide signal with the third reference intensity PW3.

Once a guide signal is transmitted by the charging station 100 in the above-described manner, the mobile robot 200 receives the guide signal, determines the location of the mobile robot 200, the distance between the mobile robot 200 and the charging station 100 and the direction of the charging station 100, and returns to the charging station 100 based on the results of the determination. For example, if the IR transmitter 132 of the charging station 100 includes ninth through fifteenth IR transmission modules which respectively transmit data signals a4, c4, e4, f4, g4, h4, and i4, the robot control unit 210 of the mobile robot 200 may determine the location of the mobile robot 200 based on which of the data signals a4, c4, e4, f4, g4, h4, and i4 are received. More specifically, the robot control unit 210 determines whether the mobile robot 200 should be headed left or right based on whichever of the data signals a4, c4, e4, and f4 are received. Also, the robot control unit 210 may determine the distance between the mobile robot 200 and the charging station 100 and whether the mobile robot 200 should be headed forward or backward based on whichever of the data signals g4, h4, and i4 are received.

The determination of the location of the mobile robot 200 when the communication range of the charging station 100 is divided as illustrated in FIG. 9 will hereinafter be described in further detail.

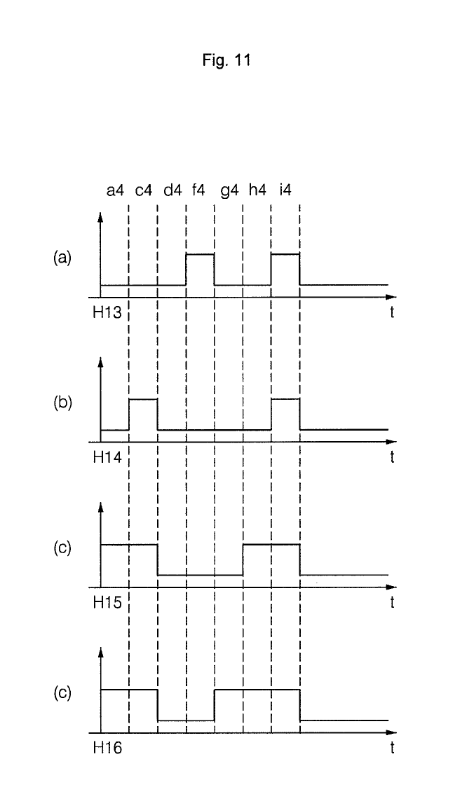

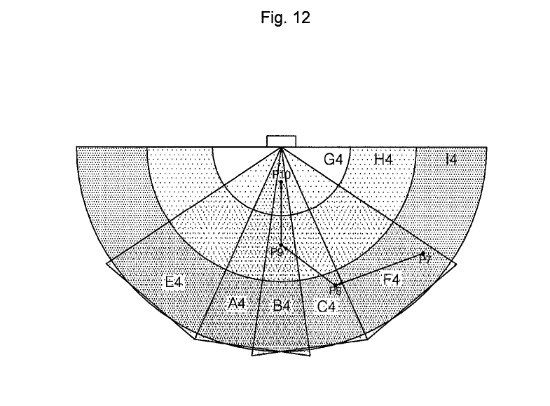

FIG. 11 illustrates the waveforms of a plurality of guide signals received by the mobile robot 200, according to another embodiment of the present invention. In this embodiment, the IR transmitter 132 of the charging station 100 includes ninth through fifteenth IR transmission modules which respectively transmit data signals a4, c4, e4, f4, g4, h4, and i4, and the communication range of the charging station 100 is divided as illustrated in FIG. 9

More specifically, FIG. 11(a) illustrates a thirteenth guide signal received by the mobile robot 200. Referring to FIG. 11(a), a first signal is received for one unit time period three unit time periods after the reception of a thirteenth header signal H13, and a second signal is received for one unit time period two unit time periods after the reception of the first signal. Thus, the robot control unit 210 of the mobile robot 200 determines that two data signals f4 and i4 respectively transmitted by the twelfth and fifteenth IR transmission modules have been received in a row, and that the mobile robot 200 is located in the overlapping area of the twenty fifth area F4 and the twenty eighth area I4.

FIG. 11(b) illustrates a fourteenth guide signal received by the mobile robot 200. Referring to FIG. 11(b), a data signal c4 transmitted by the tenth IR transmission module is received one unit time period after the reception of a fourteenth header signal H14, and a data signal i4 transmitted by the fifteenth IR transmission module is received four unit time periods after the reception of the data signal c4. Thus, the robot control unit 210 determines that the mobile robot 200 is located in the overlapping area of the twenty third area C3 and the twenty fifth area I4. Since the mobile robot 200 is determined to have moved from the overlapping area of the twenty fifth area F4 and the twenty eighth area I4 to the overlapping area of the twenty third area C3 and the twenty fifth area I4, the robot control unit 210 controls the mobile robot 200 to be headed right.

FIG. 11(c) illustrates a fifteenth guide signal received by the mobile robot 200. Referring to FIG. 11(c), two data signals a4 and c4 respectively transmitted by the ninth and tenth IR transmission modules are received in a row immediately after the reception of a fifteenth header signal H15, and two data signals h4 and i4 respectively transmitted by the fourteenth and fifteenth IR transmission modules are received in a row three unit time periods after the reception of the data signal c4. Thus, the robot control unit 210 determines that the mobile robot 200 is located in the overlapping area of the twenty second area B4 and the twenty seventh area H4.

FIG. 11(d) illustrates a sixteenth guide signal received by the mobile robot 200. Referring to FIG. 11(d), two data signals a4 and c4 respectively transmitted by the ninth and tenth IR transmission modules are received in a row immediately after the reception of a sixteenth header signal H16, and three data signals g4, h4 and i4 respectively transmitted by the thirteenth, fourteenth and fifteenth IR transmission modules are received in a row two unit time periods after the reception of the data signal c4. Thus, the robot control unit 210 determines that the mobile robot 200 is located in the overlapping area of the twenty second area B4 and the twenty sixth area G4.

The traveling path of the mobile robot 200 in response to the thirteenth through sixteenth guide signals of FIG. 11 will hereinafter be described in detail with reference to FIG. 12.

FIG. 12 illustrates the traveling path of the mobile robot 200 in response to the thirteenth through sixteenth guide signals of FIG. 11. Referring to FIG. 12, since the mobile robot 200 moves from a seventh point P7 in the overlapping area of the twenty fifth area F4 and the twenty eighth area I4 to an eighth point P8 in the overlapping area of the twenty third area C4 and the twenty fifth area I4 in response to the thirteenth and fourteenth guide signals, the robot control unit 210 of the mobile robot 200 sets the heading direction of the mobile robot 200 so that the mobile robot 200 can be headed right forward.

The robot control unit 210 detects that the mobile robot 200 has moved from the eighth point P8 to a ninth point P9 based on the fifteenth guide signal, and determines that the charging station 100 is on a right forward side of the mobile robot 200. Thereafter, the robot control unit 210 sets the heading direction of the mobile robot 200 accordingly. When the mobile robot 200 moves from the ninth point P9 to a tenth point P10, the robot control unit 210 controls the mobile robot 200 to move forward. If no data signals a4 and c4 are received during the movement of the mobile robot 200 from the ninth point P9 to the tenth point P10, the robot control unit 210 may reset the heading direction of the mobile robot 200.

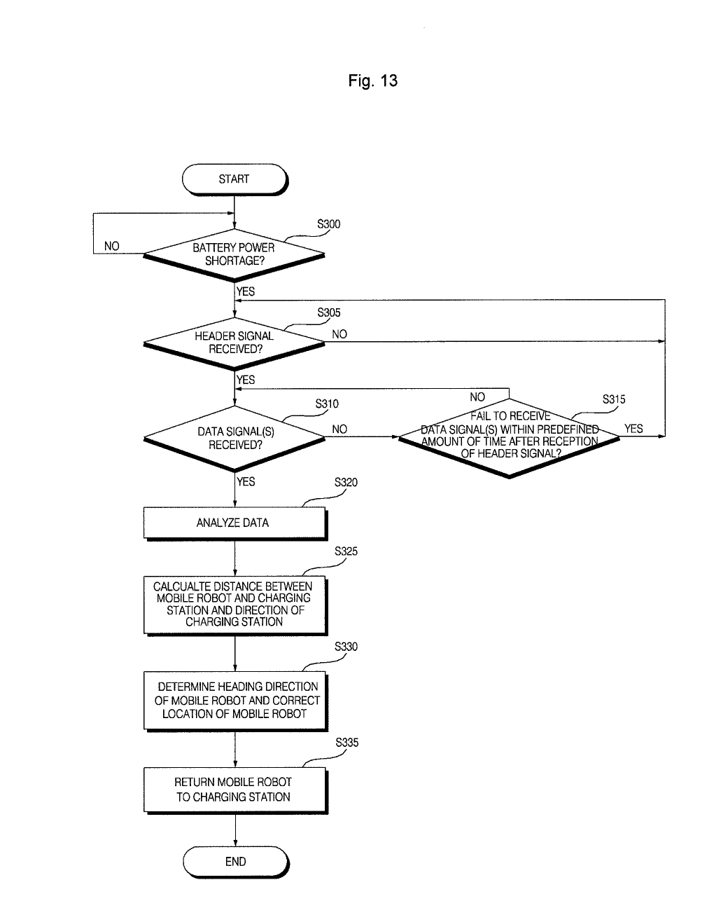

An operation of the mobile robot 200 in association with the charging station will hereinafter be described in detail with reference to FIG. 13. FIG. 13 illustrates a method of returning a mobile robot to a charging station according to an embodiment of the present invention. Referring to FIG. 13, the mobile robot 200 detects whether there is a battery power shortage by measuring the remaining power of the battery 240 after or while performing a predetermined operation (S300).

If a battery power shortage is detected, the robot control unit 210 of the mobile robot 200 sets the mobile robot 200 to return to the charging station 100 at the request of the battery detection unit 230 by controlling the travel unit 250.

The robot control unit 210 may set the path to the charging station 100 and the heading direction of the mobile robot 200 based on a number of guide signals received by the signal reception unit 220.

More specifically, when the RF receiver 221 of the signal reception unit 220 receives a header signal (S305), the robot control unit 210 counts time until at least one data signal is received, and calculates the time taken to receive the data signal.

Thereafter, the robot control unit 210 determines whether a number of data signals have been received within a predefined amount of time after the reception of the header signal (S310). If no data signals have been received within the predefined amount of time after the reception of the header signal (S315), the robot control unit 210 determines that the mobile robot 200 is not located in a docking area, and the method returns to operation S305.

On the other hand, if a number of data signals have been received within a predefined amount of time after the reception of the header signal, the robot control unit 210 analyzes the header signal and the data signals (S320).

More specifically, the robot control unit 210 determines the types of the data signal by calculating the time taken to receive the data signals and the length of an interval, if any, between the reception of the header signal and the reception of the data signals and comparing the results of the determination with the length of a unit time period, and determines the location of the mobile robot 200, the distance between the mobile robot 200 and the charging station 100, and the direction of the charging station 100 based on the types of the data signals (S325).

If the IR transmitter 132 of the charging station 100 includes ninth through fifteenth IR transmission modules which respectively transmit data signals a4, c4, e4, f4, g4, h4, and i4 and the communication range of the charging station is divided as illustrated in FIG. 9, the robot control unit 210 may determine whether the mobile robot 200 should be headed left or right based on whichever of the data signals a4, c4, e4, and f4 are received. Also, the robot control unit 210 may determine the distance between the mobile robot 200 and the charging station 100 and whether the mobile robot 200 should be headed forward or backward based on whichever of the data signals g4, h4, and i4 are received.

The robot control unit 210 sets the heading direction of the mobile robot 200 according to the distance between the mobile robot 200 and the charging station 100 and the direction of the charging station 100 (S330) and corrects the location of the mobile robot 200 so that the mobile robot 200 can move according to the result of the setting.

The mobile robot 200 may repeatedly perform the above-described operations based on a number of guide signals received until returning to the charging station 100 (S335).

As described above, according to the present invention, it is possible to reduce the time taken to transmit or receive a guide signal by dividing the guide signal into a header signal and a number of data signals and transmitting the header signal and the data signals using different communication methods. Thus, it is possible to reduce data loss during the transmission of a guide signal and to transmit considerable amounts of time within a given amount of time. In addition, according to the present invention, it is possible to reduce the time taken to transmit or receive a guide signal and to easily determine the location and the heading direction of a mobile robot. Thus, it is possible to enable a mobile robot to travel at high speed and to increase the operating time of a mobile robot by considerably reducing the time taken for a mobile robot to return to a charging station.

While the present invention has been particularly shown and described with reference to exemplary embodiments thereof, it will be understood by those of ordinary skill in the art that various changes in form and details may be made therein without departing from the spirit and scope of the present invention as defined by the following claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although the invention has been described with reference to several exemplary embodiments, it is understood that the words that have been used are words of description and illustration, rather than words of limitation. As the present invention may be embodied in several forms without departing from the spirit or essential characteristics thereof, it should also be understood that the above-described embodiments are not limited by any of the details of the foregoing description, unless otherwise specified. Rather, the above-described embodiments should be construed broadly within the spirit and scope of the present invention as defined in the appended claims. Therefore, changes may be made within the metes and bounds of the appended claims, as presently stated and as amended, without departing from the scope and spirit of the invention in its aspects.

What is claimed is:

1. A mobile robot, comprising:
a first receiver that receives a header signal transmitted via a first communication method; and
a second receiver that receives data signals transmitted via a second communication method different than the first communication method,
wherein the header signal indicates that the data signals will be transmitted, and each data signal corresponds to a specific area of communication coverage.

2. The mobile robot of claim 1, wherein the first receiver is a radio frequency receiver, and the second receiver is an infrared receiver.

3. The mobile robot of claim 2, further comprising a control unit that analyzes the header signal and the data signals, determines a location of the mobile robot based on the analysis, and sets a heading direction of the mobile robot to allow the mobile robot to travel to a charging station.

4. The mobile robot of claim 3, wherein the control unit determines the location of the mobile robot by calculating a time interval between reception of the header signal and reception of the data signals, and calculating a time taken to receive the data signals.

5. The mobile robot of claim 3, wherein the control unit determines a distance between the mobile robot and the charging station according to an intensity of the data signals.

6. The mobile robot of claim 3, wherein the control unit sets the heading direction of the mobile robot by determining a distance between the mobile robot and the charging station, and determining the areas of coverage corresponding to the data signals.

7. The mobile robot of claim 3, wherein the control unit determines that the mobile robot is located in an area in which the specific coverage areas corresponding to the data signals overlap.

8. A method for controlling a mobile robot, comprising:
receiving a header signal transmitted via a first communication method;
receiving data signals transmitted via a second communication method different than the first communication method;
analyzing the header signal and the data signals;
determining a location of the mobile robot based on the analysis; and
setting a heading direction of the mobile robot to allow the mobile robot to travel to a charging station,
wherein the header signal indicates that the data signals will be transmitted, and each data signal corresponds to a specific area of communication coverage.

9. The method of claim 8, wherein the first communication method is a radio frequency communication method, and the second communication method is an infrared communication method.

10. The method of claim 8, wherein the location of the mobile robot is determined by calculating a time interval between reception of the header signal and reception of the data signals, and calculating a time taken to receive the data signals.

11. The method of claim 8, further comprising determining a distance between the mobile robot and the charging station according to an intensity of the data signals.

12. The method of claim 8, wherein the heading direction of the mobile robot is set by determining a distance between the mobile robot and the charging station, and determining the areas of coverage corresponding to the data signals.

13. The method of claim 8, further comprising determining that the mobile robot is located in an area in which the specific coverage areas corresponding to the data signals overlap.

14. A charging station for a mobile robot, comprising:
a first transmitter that transmits a header signal via a first communication method; and
a second transmitter that transmits data signals via a second communication method different than the first communication method,
wherein the header signal indicates that the data signals will be transmitted, and each data signal corresponds to a specific area of communication coverage.

15. The charging station of claim 14, wherein the first transmitter is a radio frequency transmitter and the second transmitter is an infrared (IR) transmitter.

16. The charging station of claim 15, wherein the IR transmitter comprises a plurality of IR transmission modules having different areas of communication coverage.

17. The charging station of claim 16, further comprising a control unit that controls the IR transmission modules to sequentially transmit the data signals after the first transmitter transmits the header signal.

18. The charging station of claim 16, further comprising a control unit that varies intensities of the data signals to vary ranges of the areas of communication coverage.
